(19) United States
(12) Patent Application Publication
(10) Pub. No.: US 2022/0247532 A1
(43) Pub. Date: Aug. 4, 2022

(54) UPLINK PRECODING RESOURCE BLOCK GROUP FOR NON-CODEBOOK BASED FREQUENCY-SELECTIVE UPLINK PRECODING

(71) Applicant: QUALCOMM Incorporated, San Diego, CA (US)

(72) Inventors: Qiaoyu LI, Beijing (CN); Chao WEI, Beijing (CN); Yu ZHANG, San Diego, CA (US); Liangming WU, Beijing (CN); Chenxi HAO, Beijing (CN); Min HUANG, Beijing (CN); Hao XU, Beijing (CN); Wanshi CHEN, San Diego, CA (US)

(21) Appl. No.: 17/597,829

(22) PCT Filed: Aug. 6, 2020
(86) PCT No.: PCT/CN2020/107422

§ 371 Date: Jan. 25, 2022

(30) Foreign Application Priority Data
Aug. 9, 2019 (WO) PCTCN2019/099931

(51) Int. Cl. H04L 5/00; H04B 7/0456

(52) U.S. Cl. CPC H04L 5/0048; H04B 7/0456

(57) ABSTRACT

Various aspects of the present disclosure generally relate to wireless communication. In some aspects, a user equipment may identify a sounding reference signal (SRS) resource associated with an uplink precoding resource block group of a physical uplink shared channel (PUSCH) resource. The user equipment may precode a portion of a PUSCH communication, to be transmitted in the uplink precoding resource block group, based at least in part on the identified SRS resource. The user equipment may transmit the PUSCH communication after precoding the PUSCH communication. Numerous other aspects are provided.

### CROSS-REFERENCE TO RELATED APPLICATION

This patent application claims priority to Patent Cooperation Treaty (PCT) Application No. PCT/CN2019/099931, filed on Aug. 9, 2019, entitled “UPLINK PRECODING RESOURCE BLOCK GROUP FOR NON-CODEBOOK BASED FREQUENCY-SELECTIVE UPLINK PRECODING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for uplink precoding resource block group (PRG) for non-codebook (NCB) based frequency-selective uplink precoding.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, among other examples). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, among other examples.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

In some wireless communication systems, non-codebook (NCB)-based frequency-selective uplink precoding may be supported. NCB-based frequency-selective uplink precoding allows a UE to use different NCB-based precoders in different uplink precoding resource block groups (PRGs). A PRG includes a set of resource blocks, where resource blocks in the set are contiguous in the frequency domain. The PRG size refers to the number of resource blocks included in the uplink PRG. In order to support frequency-selective uplink precoding, a UE may use the same precoder for resource blocks within a given uplink PRG (that is, within a given frequency range corresponding to the uplink PRG). A base station may not be provided with uplink PRG information (for example, information that indicates frequency ranges associated with a given uplink PRG), which makes channel estimation difficult.

### SUMMARY

In some aspects, a method of wireless communication, performed by a user equipment, may include determining whether a bandwidth of a sounding reference signal (SRS) resource is smaller than a bandwidth of a physical uplink shared channel (PUSCH) resource or is greater than or equal to the bandwidth of the PUSCH resource. The method may include precoding a PUSCH communication, to be transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource. The method may include transmitting the precoded PUSCH communication.

In some aspects, a method of wireless communication, performed by a user equipment, may include precoding, in a first set of uplink precoding resource block groups, a first portion of a PUSCH communication that is to be transmitted in a portion of a PUSCH resource that overlaps with a bandwidth of an SRS resource. The method may include precoding, in a second set of uplink precoding resource block groups, a second portion of the PUSCH communication that is to be transmitted in a portion of the PUSCH resource that does not overlap with the bandwidth of the SRS resource. The method may include transmitting the precoded PUSCH communication.

In some aspects, a method of wireless communication, performed by a user equipment, may include identifying an SRS resource associated with an uplink precoding resource block group of a PUSCH resource. The method may include precoding a portion of a PUSCH communication, to be transmitted in the uplink precoding resource block group, based at least in part on the identified SRS resource. The method may include transmitting the precoded PUSCH communication.

In some aspects, a user equipment for wireless communication may include memory and one or more processors operatively coupled to the memory. The memory and the one or more processors may be configured to determine whether a bandwidth of an SRS resource is smaller than a bandwidth of a PUSCH resource or is greater than or equal to the bandwidth of the PUSCH resource; precode a PUSCH communication, to be transmitted in the PUSCH resource, in either: a single wideband uplink precoding resource block group, based on determining that the bandwidth of the SRS resource is smaller than the bandwidth of the PUSCH resource; or at least two precoding uplink resource block groups, based on determining that the bandwidth of the SRS resource is greater than or equal to the bandwidth of the PUSCH resource; and transmit the precoded PUSCH communication.

In some aspects, a user equipment for wireless communication may include memory and one or more processors operatively coupled to the memory. The memory and the one or more processors may be configured to precode, in a first set of uplink precoding resource block groups, a first portion of a PUSCH communication that is to be transmitted in a portion of a PUSCH resource that overlaps with a bandwidth of an SRS resource. The memory and the one or more processors may be configured to precode, in a second set of uplink precoding resource block groups, a second portion of the PUSCH communication that is to be transmitted in a portion of the PUSCH resource that does not overlap with the bandwidth of the SRS resource. The memory and the one or more processors may be configured to transmit the precoded PUSCH communication.

In some aspects, a user equipment for wireless communication may include memory and one or more processors operatively coupled to the memory. The memory and the one or more processors may be configured to identify an SRS resource associated with an uplink precoding resource block group of a PUSCH resource. The memory and the one or more processors may be configured to precode a portion of a PUSCH communication, to be transmitted in the uplink precoding resource block group, based at least in part on the identified SRS resource. The memory and the one or more processors may be configured to transmit the precoded PUSCH communication.

In some aspects, a non-transitory computer-readable medium may store one or more instructions for wireless communication. The one or more instructions, when executed by one or more processors of a user equipment, may cause the one or more processors to determine whether a bandwidth of an SRS resource is smaller than a bandwidth of a PUSCH resource or is greater than or equal to the bandwidth of the PUSCH resource. The one or more instructions, when executed by one or more processors of the user equipment, may cause the one or more processors to precode a PUSCH communication, to be transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource. The one or more instructions, when executed by one or more processors of the user equipment, may cause the one or more processors to transmit the precoded PUSCH communication.

In some aspects, a non-transitory computer-readable medium may store one or more instructions for wireless communication. The one or more instructions, when executed by one or more processors of a user equipment, may cause the one or more processors to precode, in a first set of uplink precoding resource block groups, a first portion of a PUSCH communication that is to be transmitted in a portion of a PUSCH resource that overlaps with a bandwidth of an SRS resource. The one or more instructions, when executed by one or more processors of the user equipment, may cause the one or more processors to precode, in a second set of uplink precoding resource block groups, a second portion of the PUSCH communication that is to be transmitted in a portion of the PUSCH resource that does not overlap with the bandwidth of the SRS resource. The one or more instructions, when executed by one or more processors of the user equipment, may cause the one or more processors to transmit the precoded PUSCH communication.

In some aspects, a non-transitory computer-readable medium may store one or more instructions for wireless communication. The one or more instructions, when executed by one or more processors of a user equipment, may cause the one or more processors to identify an SRS resource associated with an uplink precoding resource block group of a PUSCH resource. The one or more instructions, when executed by one or more processors of the user equipment, may cause the one or more processors to precode a portion of a PUSCH communication, to be transmitted in the uplink precoding resource block group, based at least in part on the identified SRS resource. The one or more instructions, when executed by one or more processors of the user equipment, may cause the one or more processors to transmit the precoded PUSCH communication.

In some aspects, an apparatus for wireless communication may include means for determining whether a bandwidth of an SRS resource is smaller than a bandwidth of a PUSCH resource or is greater than or equal to the bandwidth of the PUSCH resource. The apparatus may include means for precoding a PUSCH communication, to be transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is to be greater than or equal to the bandwidth of the PUSCH resource. The apparatus may include means for transmitting the precoded PUSCH communication.

In some aspects, an apparatus for wireless communication may include means for precoding, in a first set of uplink precoding resource block groups, a first portion of a PUSCH communication that is to be transmitted in a portion of a PUSCH resource that overlaps with a bandwidth of an SRS resource. The apparatus may include means for precoding, in a second set of uplink precoding resource block groups, a second portion of the PUSCH communication that is to be transmitted in a portion of the PUSCH resource that does not overlap with the bandwidth of the SRS resource. The apparatus may include means for transmitting the precoded PUSCH communication.

In some aspects, an apparatus for wireless communication may include means for identifying an SRS resource associated with an uplink precoding resource block group of a PUSCH resource. The apparatus may include means for precoding a portion of a PUSCH communication, to be transmitted in the uplink precoding resource block group, based at least in part on the identified SRS resource. The apparatus may include means for transmitting the precoded PUSCH communication.

In some aspects, a method of wireless communication, performed by a base station, may include determining whether a bandwidth of an SRS resource is smaller than a bandwidth of a PUSCH resource or is greater than or equal to the bandwidth of the PUSCH resource. The method may include and receiving a PUSCH communication, transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource.

In some aspects, a method of wireless communication, performed by a base station, may include receiving, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. The method may include receiving, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, a method of wireless communication, performed by a base station, may include identifying an SRS resource associated with an uplink precoding resource block group of a PUSCH resource. The method may include receiving a portion of a PUSCH communication, transmitted in the uplink precoding resource block group, based at least in part on the identified SRS resource, wherein the portion of the PUSCH communication was precoded in the uplink resource block group based at least in part on the identified SRS resource.

In some aspects, a base station for wireless communication may include memory and one or more processors operatively coupled to the memory. The memory and the one or more processors may be configured to determine whether a bandwidth of an SRS resource is smaller than a bandwidth of a PUSCH resource or is greater than or equal to the bandwidth of the PUSCH resource. The memory and the one or more processors may be configured to receive a PUSCH communication, transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource.

In some aspects, a base station for wireless communication may include memory and one or more processors operatively coupled to the memory. The memory and the one or more processors may be configured to receive, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. The memory and the one or more processors may be configured to receive, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, a base station for wireless communication may include memory and one or more processors operatively coupled to the memory. The memory and the one or more processors may be configured to identify an SRS resource associated with an uplink precoding resource block group of a PUSCH resource. The memory and the one or more processors may be configured to and receive a portion of a PUSCH communication, transmitted in the uplink precoding resource block group, based at least in part on the identified SRS resource, wherein the portion of the PUSCH communication was precoded in the uplink resource block group based at least in part on the identified SRS resource.

In some aspects, a non-transitory computer-readable medium may store one or more instructions for wireless communication. The one or more instructions, when executed by one or more processors of a base station, may cause the one or more processors to determine whether a bandwidth of an SRS resource is smaller than a bandwidth of a PUSCH resource or is greater than or equal to the bandwidth of the PUSCH resource. The one or more instructions, when executed by one or more processors of the base station, may cause the one or more processors to receive a PUSCH communication, transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource.

In some aspects, a non-transitory computer-readable medium may store one or more instructions for wireless communication. The one or more instructions, when executed by one or more processors of a base station, may cause the one or more processors to receive, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. The one or more instructions, when executed by one or more processors of the base station, may cause the one or more processors to receive, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, a non-transitory computer-readable medium may store one or more instructions for wireless communication. The one or more instructions, when executed by one or more processors of a base station, may cause the one or more processors to identify an SRS resource associated with an uplink precoding resource block group of a PUSCH resource. The one or more instructions, when executed by one or more processors of the base station, may cause the one or more processors to receive a portion of a PUSCH communication, transmitted in the uplink precoding resource block group, based at least in part on the identified SRS resource, wherein the portion of the PUSCH communication was precoded in the uplink resource block group based at least in part on the identified SRS resource.

In some aspects, an apparatus for wireless communication may include means for determining whether a bandwidth of an SRS resource is smaller than a bandwidth of a PUSCH resource or is greater than or equal to the bandwidth of the PUSCH resource. The apparatus may include means for receiving a PUSCH communication, transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource.

In some aspects, an apparatus for wireless communication may include means for receiving, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. The apparatus may include means for receiving, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, an apparatus for wireless communication may include means for identifying an SRS resource associated with an uplink precoding resource block group of a PUSCH resource. The apparatus may include and means for receiving a portion of a PUSCH communication, transmitted in the uplink precoding resource block group, based at least in part on the identified SRS resource, wherein the portion of the PUSCH communication was precoded in the uplink resource block group based at least in part on the identified SRS resource.

Aspects generally include a method, apparatus, system, computer program product, non-transitory computer-readable medium, user equipment, base station, wireless communication device, or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIGS. 3, 4A-4C, and 5A-5F are diagrams associated with uplink PRG for NCB-based frequency-selective uplink precoding, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a user equipment, in accordance with various aspects of the present disclosure.

FIG. 8 is a diagram illustrating an example process performed, for example, by a user equipment, in accordance with various aspects of the present disclosure.

FIG. 9 is a diagram illustrating an example process performed, for example, by a base station, in accordance with various aspects of the present disclosure.

FIG. 10 is a diagram illustrating an example process performed, for example, by a base station, in accordance with various aspects of the present disclosure.

FIG. 11 is a diagram illustrating an example process performed, for example, by a base station, in accordance with various aspects of the present disclosure.

FIGS. 12 and 13 are block diagrams of example apparatuses for wireless communication in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, among other examples (collectively referred to as “elements”). These elements may be implemented using hardware, software, or combinations thereof. Whether such elements are implemented as hardware or software depends upon the particular application and design constraints imposed on the overall system.

Various aspects relate generally to uplink precoding resource block groups (PRGs). Some aspects more specifically relate to uplink PRG for non-codebook (NCB) based frequency-selective uplink precoding. In general, NCB-based precoding provides a UE with flexibility to select a precoder that is well suited to the transmission channel. The use of NCB-based uplink precoding reduces downlink signaling because a base station need not signal a precoding matrix indicator (PMI) or precoder to the UE. NCB-based frequency-selective uplink precoding allows the UE to use different NCB-based precoders in different uplink PRGs, meaning that the UE has the flexibility to select a precoder that is well suited for a transmission in a given uplink PRG. To support frequency-selective uplink precoding, a UE may use the same precoder for resource blocks within a given uplink PRG (that is, within a given frequency range corresponding to the uplink PRG).

In one example aspect for implementing uplink PRG for NCB-based frequency-selective precoding, a UE may precode an physical uplink shared channel (PUSCH) communication in either a single wideband uplink PRG (for example, based on determining that a bandwidth of an SRS resource is smaller than a bandwidth of a PUSCH resource) or in at least two uplink PRGs (for example, based on determining that the bandwidth of the SRS resource is greater than or equal to the bandwidth of the PUSCH resource). In another example aspect for implementing uplink PRG for NCB-based frequency-selective precoding, a UE may precode, in a first set of uplink PRGs, a first portion of a PUSCH communication that is to be transmitted in a portion of a PUSCH resource that overlaps with a bandwidth of an SRS resource, and may precode, in a second set of uplink PRGs, a second portion of the PUSCH communication that is to be transmitted in a portion of the PUSCH resource that does not overlap with the bandwidth of the SRS resource. In another example aspect for implementing uplink PRG for NCB-based frequency-selective precoding, a UE may precode a portion of a PUSCH communication, to be transmitted in an uplink PRG, based at least in part on identifying an SRS resource associated with the uplink PRG.

Particular aspects of the subject matter described in this disclosure can be implemented to realize one or more of the following potential advantages. In some examples, the described techniques can be used to improve channel estimation by providing for improved control of frequency-selective precoders when implementing the use of uplink PRG for NCB-based frequency-selective uplink precoding. Therefore, UE is provided with flexibility to select a precoder that is well suited for a transmission in a given uplink PRG, while improving channel estimation.

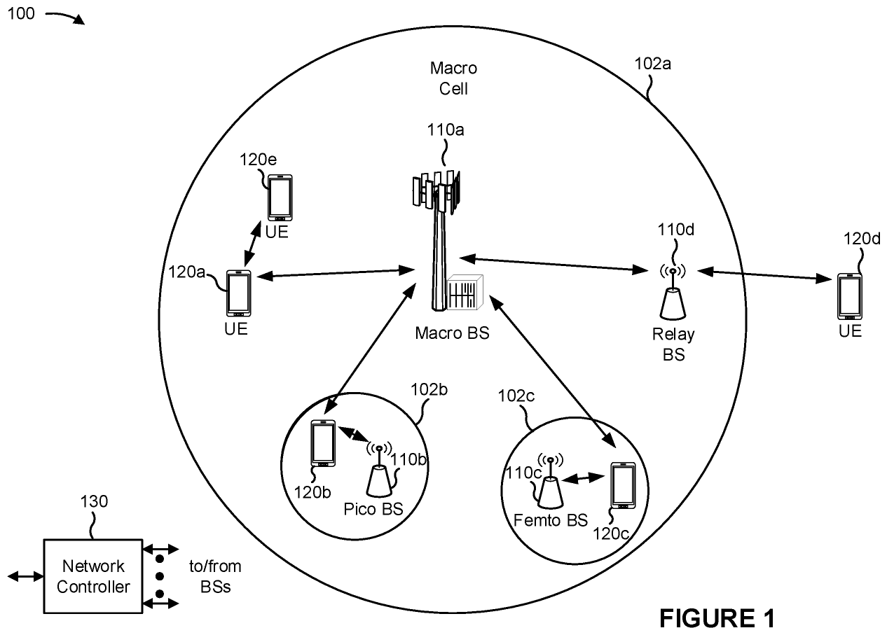

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), among other examples. Each BS may provide communication coverage for a particular geographic area. In 3GPP, the term “cell” can refer to a coverage area of a BS or a BS subsystem serving this coverage area, depending on the context in which the term is used.

A BS may provide communication coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another or to one or more other BSs or network nodes (not shown) in the wireless network 100 through various types of backhaul interfaces such as a direct physical connection, a virtual network, or the like using any suitable transport network.

Wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, among other examples.

Wireless network 100 may be a heterogeneous network that includes BSs of different types, for example, macro BSs, pico BSs, femto BSs, relay BSs, among other examples. These different types of BSs may have different transmit power levels, different coverage areas, and different impacts on interference in wireless network 100. For example, macro BSs may have a high transmit power level (for example, 5 to 40 Watts) whereas pico BSs, femto BSs, and relay BSs may have lower transmit power levels (for example, 0.1 to 2 Watts).

A network controller 130 may couple to a set of BSs and may provide coordination and control for these BSs. Network controller 130 may communicate with the BSs via a backhaul. The BSs may also communicate with one another, for example, directly or indirectly via a wireless or wireline backhaul.

UEs 120 (for example, 120a, 120b, 120c) may be dispersed throughout wireless network 100, and each UE may be stationary or mobile. A UE may also be referred to as an access terminal, a terminal, a mobile station, a subscriber unit, a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, among other examples, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband internet of things) devices. Some UEs may be considered a Customer Premises Equipment (CPE). UE 120 may be included inside a housing that houses components of UE 120, such as processor components, memory components, among other examples.

In general, any number of wireless networks may be deployed in a given geographic area. Each wireless network may support a particular RAT and may operate on one or more frequencies. A RAT may also be referred to as a radio technology, an air interface, among other examples. A frequency may also be referred to as a carrier, a frequency channel, among other examples. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, among other examples), a mesh network, among other examples. In such examples, the UE 120 may perform scheduling operations, resource selection operations, or other operations described elsewhere herein as being performed by the base station 110.

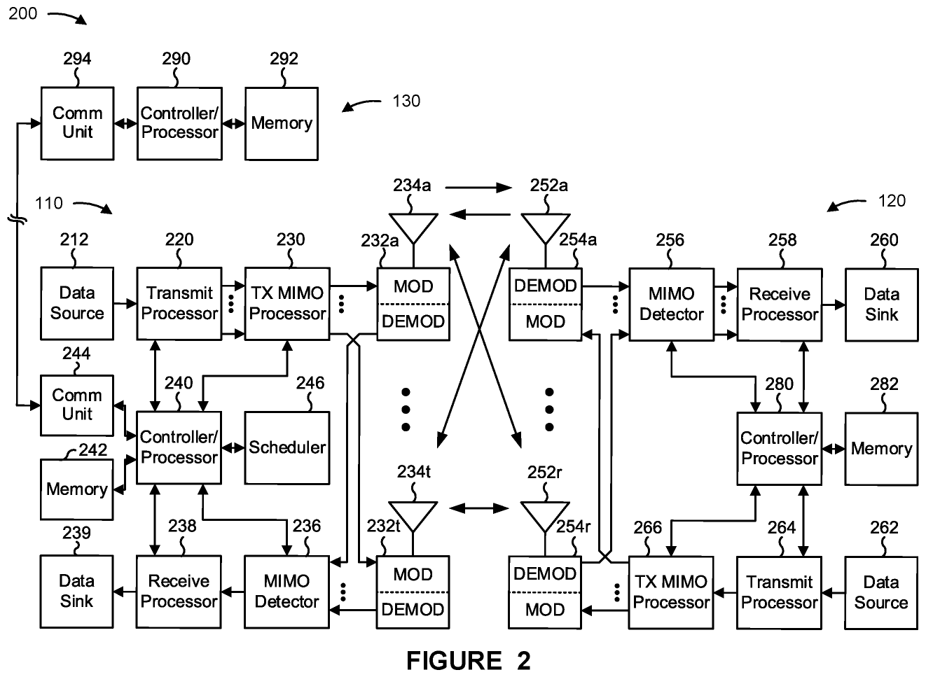

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Transmit processor 220 may also process system information (for example, for semi-static resource partitioning information (SRPI) among other examples) and control information (for example, CQI requests, grants, upper layer signaling, among other examples) and provide overhead symbols and control symbols. Transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for OFDM among other examples) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM among other examples) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), among other examples. In some aspects, one or more components of UE 120 may be included in a housing.

On the uplink, at UE 120, a transmit processor 264 may receive and process data from a data source 262 and control information (for example, for reports comprising RSRP, RSSI, RSRQ, CQI, among other examples) from controller/processor 280. Transmit processor 264 may also generate reference symbols for one or more reference signals. The symbols from transmit processor 264 may be precoded by a TX MIMO processor 266 if applicable, further processed by modulators 254a through 254r (for example, for DFT-s-OFDM, CP-OFDM, among other examples), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

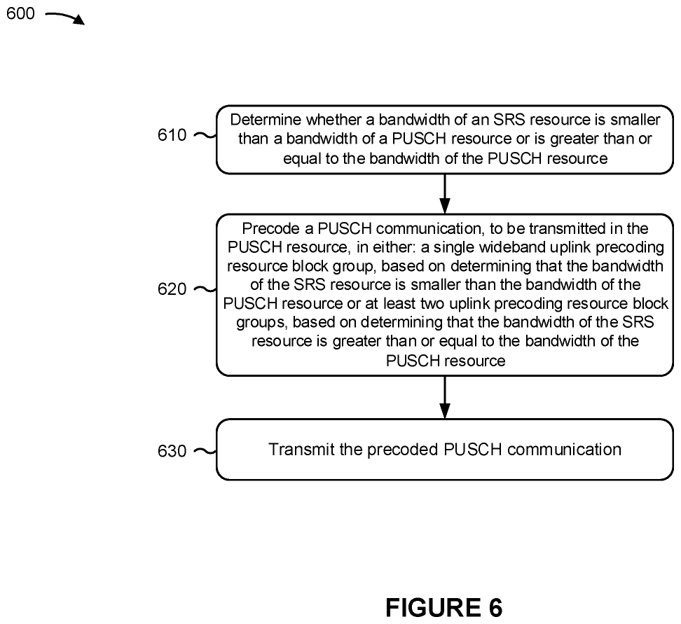

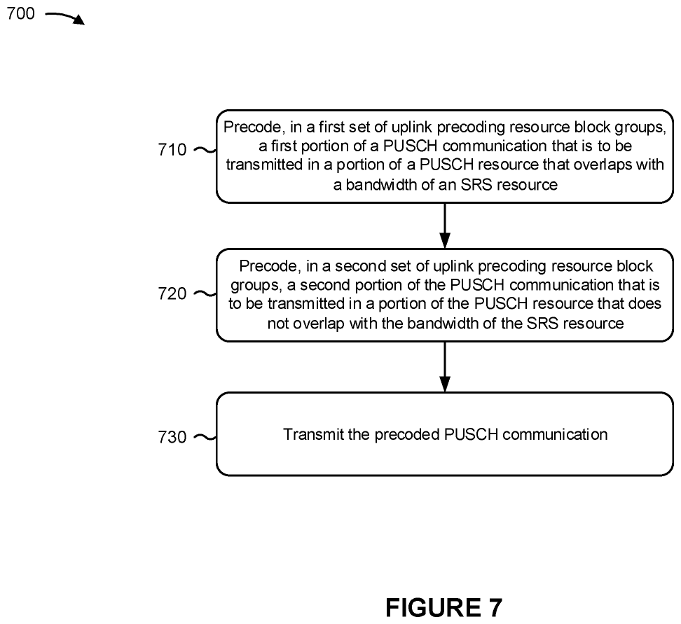

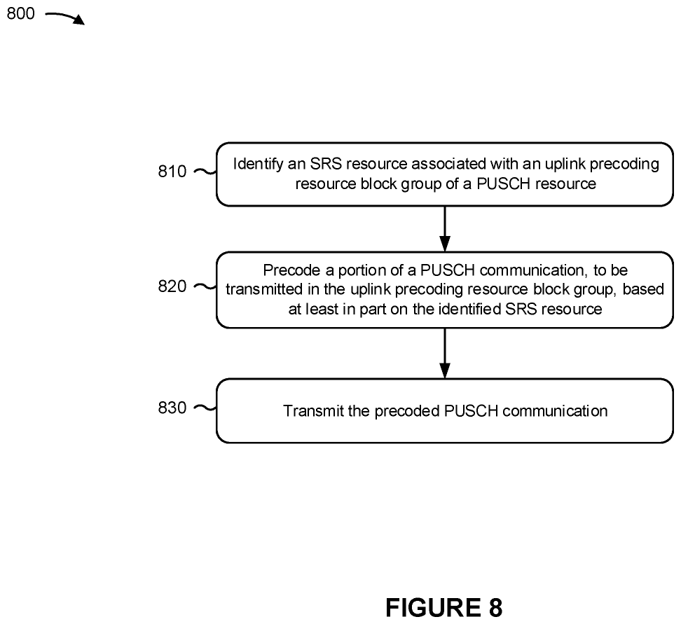

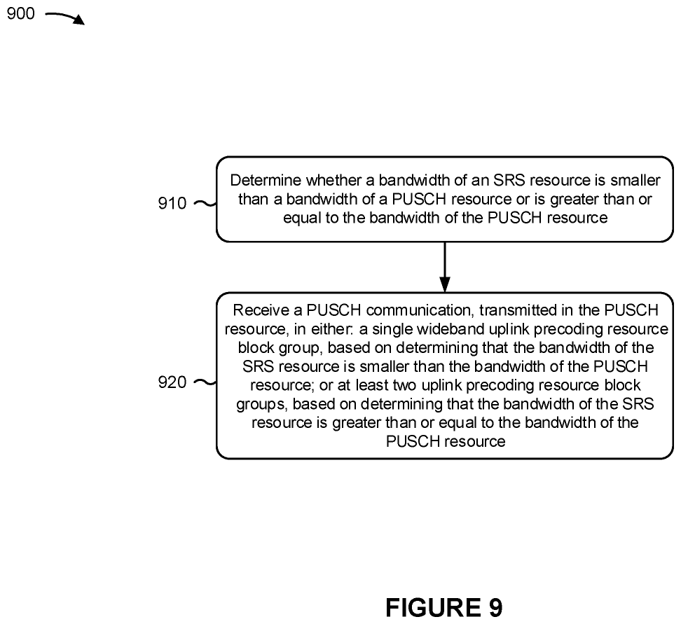

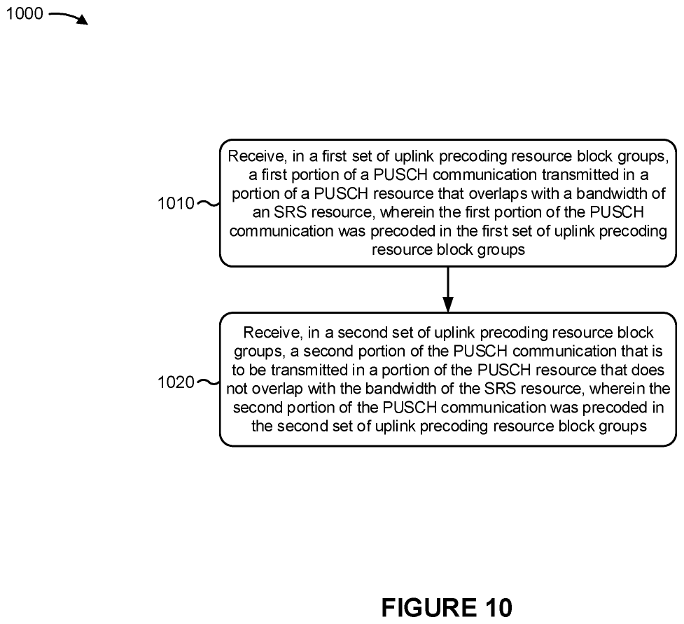

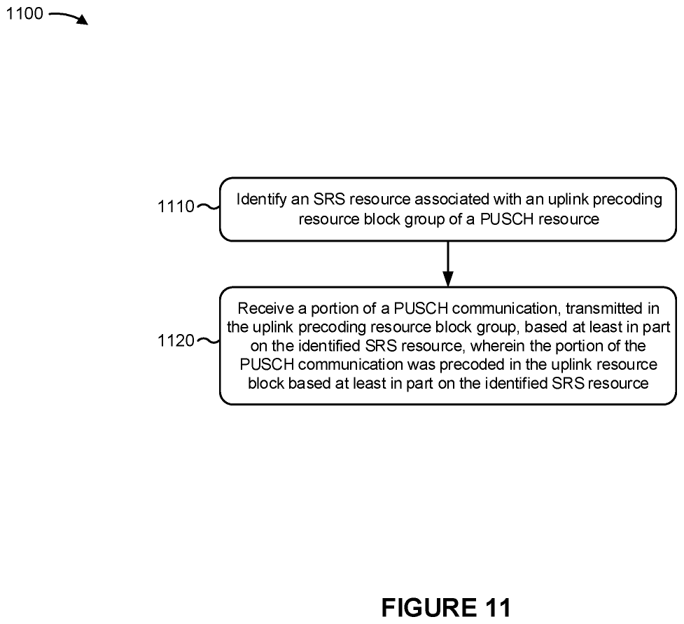

Controller/processor 240 of base station 110, controller/processor 280 of UE 120, or any other component(s) of FIG. 2 may perform one or more techniques associated with uplink precoding resource block groups (PRGs) for non-codebook (NCB) based frequency-selective uplink precoding, as described in more detail elsewhere herein. For example, controller/processor 240 of base station 110, controller/processor 280 of UE 120, or any other component(s) of FIG. 2 may perform or direct operations of, for example, process 600 of FIG. 6, process 700 of FIG. 7, process 800 of FIG. 8, process 900 of FIG. 9, process 1000 of FIG. 10, process 1100 of FIG. 11, or other processes as described herein. Memories 242 and 282 may store data and program codes for base station 110 and UE 120, respectively. In some aspects, memory 242 or memory 282 may comprise a non-transitory computer-readable medium storing one or more instructions for wireless communication. For example, the one or more instructions, when executed by one or more processors of the base station 110 or the UE 120, may perform or direct operations of, for example, process 600 of FIG. 6, process 700 of FIG. 7, process 800 of FIG. 8, process 900 of FIG. 9, process 1000 of FIG. 10, process 1100 of FIG. 11, or other processes as described herein. A scheduler 246 may schedule UEs for data transmission on the downlink or uplink.

In some aspects, UE 120 may include means for determining whether a bandwidth of an SRS resource is smaller than a bandwidth of a PUSCH resource or is greater than or equal to the bandwidth of the PUSCH resource; means for precoding a PUSCH communication, to be transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource; means for transmitting the precoded PUSCH communication; among other examples. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, among other examples.

In some aspects, UE 120 may include means for precoding, in a first set of uplink precoding resource block groups, a first portion of a PUSCH communication that is to be transmitted in a portion of a PUSCH resource that overlaps with a bandwidth of an SRS resource; means for precoding, in a second set of uplink precoding resource block groups, a second portion of the PUSCH communication that is to be transmitted in a portion of the PUSCH resource that does not overlap with the bandwidth of the SRS resource; means for transmitting the precoded PUSCH communication; among other examples. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, among other examples.

In some aspects, UE 120 may include means for identifying an SRS resource associated with an uplink precoding resource block group of a PUSCH resource; means for precoding a portion of a PUSCH communication, to be transmitted in the uplink precoding resource block group, based at least in part on the identified SRS resource; means for transmitting the precoded PUSCH communication; among other examples. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, among other examples.

In some aspects, base station 110 may include means for determining whether a bandwidth of an SRS resource is smaller than a bandwidth of a PUSCH resource or is greater than or equal to the bandwidth of the PUSCH resource; means for receiving a PUSCH communication, transmitted in the PUSCH resource, in either: a single wideband uplink precoding resource block group, based on determining that the bandwidth of the SRS resource is smaller than the bandwidth of the PUSCH resource; or at least two uplink precoding resource block groups, based on determining that the bandwidth of the SRS resource is greater than or equal to the bandwidth of the PUSCH resource; among other examples. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, among other examples.

In some aspects, base station 110 may include means for receiving, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups; means for receiving, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups; among other examples. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, among other examples.

In some aspects, base station 110 may include means for identifying a sounding reference signal (SRS) resource associated with an uplink precoding resource block group of a PUSCH resource; means for receiving a portion of a PUSCH communication, transmitted in the uplink precoding resource block group, based at least in part on the identified SRS resource, wherein the portion of the PUSCH communication was precoded in the uplink resource block group based at least in part on the identified SRS resource; among other examples. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, among other examples.

In some wireless communication systems, a wireless communication device (for example, a UE 120, a base station 110) is capable of transmitting one or more data streams from multiple different antennas at the same time. Typically, precoding is applied to the data streams to distribute the data streams among the antennas. That is, data streams are multiplied with different weighting and phase shifting before being transmitted from respective antennas. Precoding is a process that distributes data (for example, layered data) to different antenna ports. This can provide single-stream beamforming, where the same data stream is transmitted over each of the antennas. Here, the linear combined signal transmitted from the multiple antennas results in a directional radiation beam. This is typically referred to as beamforming. In another example, known as multiple-input multiple-output (MIMO), a plurality of data streams may be precoded and transmitted from different antennas. By virtue of the spatial diversity provided by the separately located antennas, the total capacity of the channel may be multiplied by the number of layers or streams.

In some cases, in association with performing uplink precoding, a base station may provide a UE with a precoding matrix indicator (PMI) from a predefined codebook. The UE may then select the precoder from the codebook based on the PMI for an uplink transmission (for example, an uplink MIMO transmission). Alternatively, the UE may select a precoder that is not necessarily restricted to a codebook, in some cases. Such non-codebook (NCB) based precoding provides the UE with flexibility to select a precoder that is well suited to the transmission channel. In the case of NCB-based uplink precoding, downlink signaling is reduced, since the base station need not signal the PMI or precoder to the UE.

In some cases, for realization of NCB-based uplink precoding, use of only a wideband sounding reference signal (SRS) resource indicator field is supported. The wideband SRS resource indicator (SRI) field corresponds to a predetermined combination of SRS resources in a configured set of SRS resources. Here, the UE may be configured to determine a precoder and transmission rank based on the wideband SRI field. The UE may receive the wideband SRI in downlink control information (DCI). For determination of a PUSCH precoder in NCB-based uplink MIMO, signaling of only SRI(s) may be supported (without a transmitted PMI (TPMI) indication). Here, only one SRS port for each SRS resource can be configured, and a maximum number of SRS resources that can be configured for NCB-based uplink transmission is 4. Thus, a total of up to 4 SRS ports can be indicated by SRIs using one DCI field. Notably, to support higher rank transmission, multiple SRS resources should be indicated, and the UE may use a particular SRS resource to associate with the precoding of a particular PUSCH layer. Generally, the UE can be configured with only one SRS resource set with the following details: the UE can be configured to simultaneously transmit up to n SRS resources, where n is part of UE capability signalling; and the SRS resources transmitted simultaneously occupy the same resource blocks (RBs). The rank of the uplink transmission can be derived from the SRI field, and encoding of a demodulation reference signal (DMRS) indicator is determined from the derived rank. The base station may be configured to determine the precoder used by the UE based on this DMRS indicator.

In some wireless communication systems, NCB-based frequency-selective uplink precoding may be supported. NCB-based frequency-selective uplink precoding allows a UE to use different NCB-based precoders in different uplink precoding resource block groups (PRGs). A PRG includes a set of resource blocks, where resource blocks in the set are contiguous in the frequency domain. The PRG size refers to the number of resource blocks included in the uplink PRG. In order to support frequency-selective uplink precoding, a UE may use the same precoder for resource blocks within a given uplink PRG (that is, within a given frequency range corresponding to the uplink PRG). A base station may not be provided with uplink PRG information (for example, information that indicates frequency ranges associated with a given uplink PRG), which makes channel estimation difficult. Thus, when implementing uplink PRGs, an association between uplink PRG and SRS bandwidth can be considered when allowing the UE to select sub-band specific precoders.

Some aspects described herein provide techniques and apparatuses for uplink PRG for NCB-based frequency-selective uplink precoding. In some aspects, the techniques and apparatuses for uplink PRG for NCB-based frequency-selective precoding improve channel estimation by providing for improved control of frequency-selective precoders when implementing the use of uplink PRG for NCB-based frequency-selective uplink precoding. Example aspects for implementing uplink PRG for NCB-based frequency-selective precoding in various scenarios are described below.

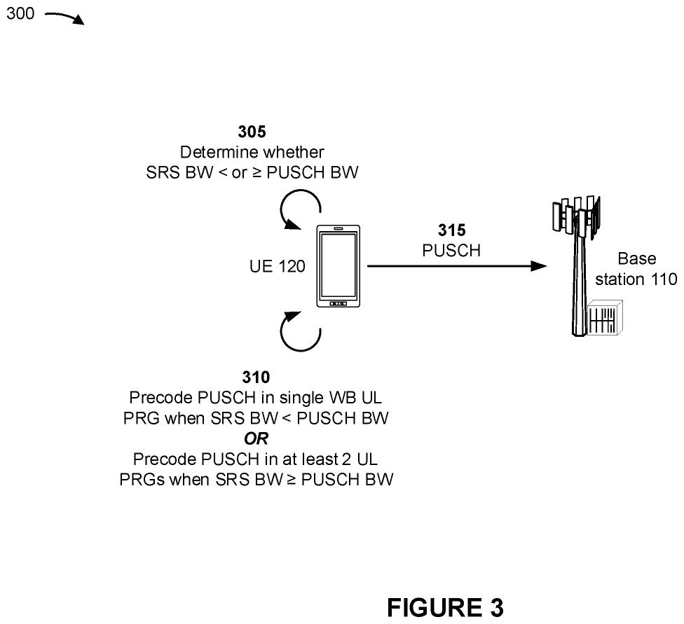

FIGS. 3, 4A-4C, and 5A-5F are diagrams associated with uplink PRG for NCB-based frequency-selective uplink precoding, in accordance with various aspects of the present disclosure.

In some aspects a UE (for example, UE 120) may be configured to precode a PUSCH communication in one or more wideband uplink PRGs (for example, using a wideband precoder) or in one or more uplink PRGs (for example, using one or more sub-band specific precoders) based at least in part on a bandwidth of an SRS resource and a bandwidth of a PUSCH resource associated with transmitting the PUSCH communication.

FIG. 3 is a diagram of a first example illustrating precoding of a PUSCH communication based at least in part on a bandwidth of an SRS resource and a bandwidth of a PUSCH resource associated with transmitting the PUSCH communication. In FIG. 3, a UE (for example, UE 120) is configured by a base station (for example, base station 110) with an SRS resource, and is scheduled by the base station to transmit a PUSCH communication in a PUSCH resource.

As shown in FIG. 3, in a first operation 305, the UE may determine whether a bandwidth of the SRS resource configured for the UE is smaller than a bandwidth of the PUSCH resource or is greater than or equal to the bandwidth of the PUSCH resource. For example, the UE may compare a bandwidth of the configured SRS resource and a bandwidth of the PUSCH resource in order to determine whether the bandwidth of the SRS resource is smaller than, or greater than or equal to, the bandwidth of the PUSCH resource.

In a second operation 310, in some aspects, when the UE determines that the bandwidth of the SRS resource is smaller than the bandwidth of the PUSCH resource, the UE may precode the PUSCH communication in a single wideband uplink PRG (for example, using a wideband precoder). Alternatively, as further indicated by operation 310, when the UE determines that the bandwidth of the SRS resource is greater than or equal to the bandwidth of the PUSCH resource, the UE may precode the PUSCH communication in at least two uplink PRGs (for example, using one or more sub-band specific precoders).

In a third operation 315, in some aspects, the UE may transmit the PUSCH communication in the PUSCH resource after precoding the PUSCH communication (for example, in the single wideband uplink PRG or in the at least two uplink PRGs).

In some aspects, a base station (for example, base station 110) may receive the PUSCH communication after transmission of the PUSCH communication by the UE. For example, the base station may determine whether the bandwidth of the SRS resource is smaller than the bandwidth of the PUSCH resource or is greater than or equal to the bandwidth of the PUSCH resource (for example, in a similar manner as that of the UE). The base station may then receive the PUSCH communication in the PUSCH resource in the single wideband uplink precoding resource block group (when the bandwidth of the SRS resource is determined to be smaller than the bandwidth of the PUSCH resource) or in at least two uplink resource block groups (when the bandwidth of the SRS resource is determined to be greater than or equal to the bandwidth of the PUSCH resource).

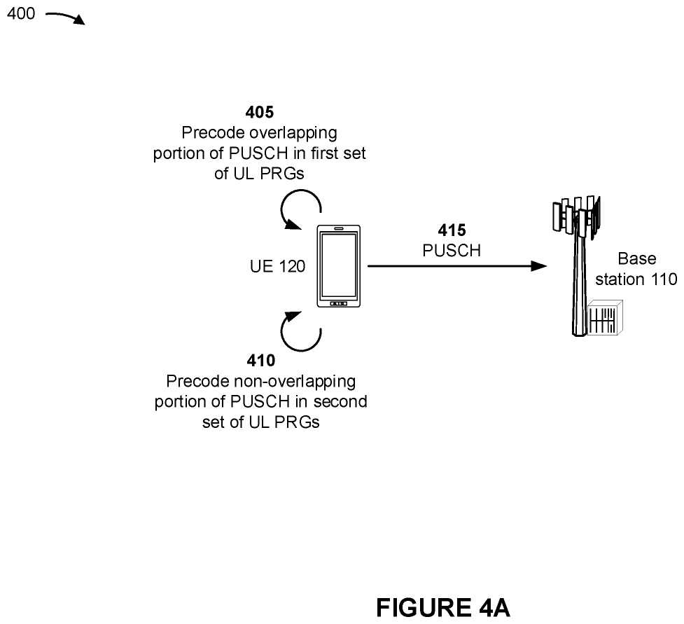

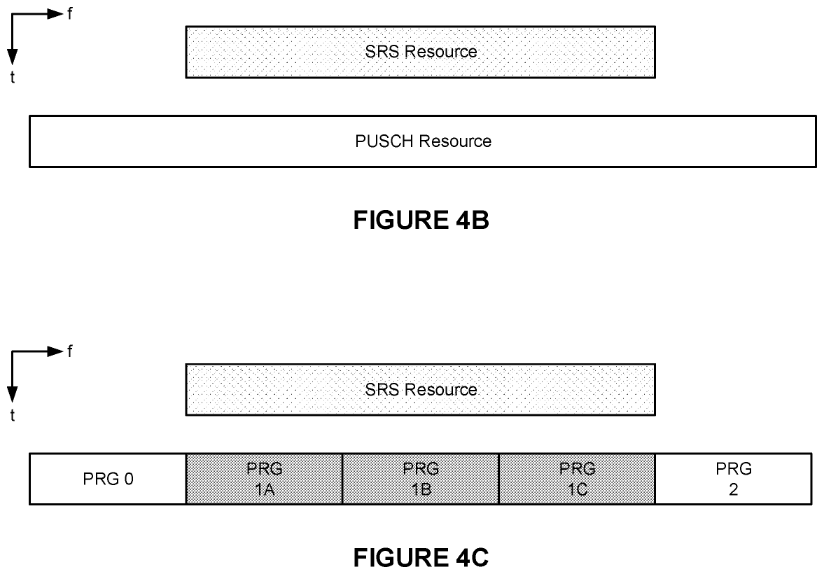

FIGS. 4A-4C are diagrams associated with a second example illustrating precoding of a PUSCH communication based at least in part on a bandwidth of an SRS resource and a bandwidth of a PUSCH resource associated with transmitting the PUSCH communication. In FIGS. 4A-4C, the UE is configured with an SRS resource, and is scheduled to transmit a PUSCH communication in a PUSCH resource.

As shown in FIG. 4A, in a first operation 405, the UE may precode a first portion of the PUSCH communication in a first set of uplink PRGs. Here, the first portion of the PUSCH communication is to be transmitted in a portion of the PUSCH resource that overlaps with a bandwidth of the SRS resource. In some aspects, the UE may use one or more sub-band specific precoders for precoding the first portion of the PUSCH communication in the first set of uplink PRGs. Thus, in some aspects, the UE may perform sub-band specific precoding for a portion of the PUSCH communication that overlaps with the SRS resource.

In a second operation 410, the UE may precode a second portion of the PUSCH communication using a second set of uplink PRGs. Here, the second portion of the PUSCH communication is to be transmitted in a portion of the PUSCH resource that does not overlap with the bandwidth of the SRS resource. In some aspects, the UE may use a wideband precoder for precoding the second portion of the PUSCH communication in the second set of uplink PRGs. Thus, in some aspects, the UE may perform wideband precoding for a portion of the PUSCH communication that does not overlap with the SRS resource.

In a third operation 415, the UE may transmit the PUSCH communication in the PUSCH resource after precoding the first and second portions of the PUSCH communication.

In some aspects, the UE may precode the first and second portions of the PUSCH communication in the above-described manner when the bandwidth of the SRS resource overlaps with the bandwidth of the PUSCH resource and when the bandwidth of the SRS resource is smaller than the bandwidth of the PUSCH resource. For example, the UE may compare a bandwidth of the configured SRS resource and a bandwidth of the PUSCH resource, and determine that the bandwidth of the SRS resource overlaps with the bandwidth of the PUSCH resource and is smaller than the bandwidth of the PUSCH resource, and may proceed accordingly.

FIGS. 4B and 4C illustrate the manner in which the UE may precode the first and second portions of the PUSCH communication as described in association with FIG. 4A. FIG. 4B illustrates an SRS resource having a smaller bandwidth than that of a PUSCH resource. FIG. 4C illustrates a manner in which the UE may precode the PUSCH communication. As shown in FIG. 4C, the UE may precode a portion of the PUSCH communication that overlaps with the bandwidth of the SRS resource in a first set of uplink PRGs (identified as PRGs 1A through 1C), and may precode a portion of the PUSCH communication that does not overlap with the SRS resource using a second set of uplink PRGs (identified as PRGs 0 and 2).

In some aspects, a base station (for example, base station 110) may receive the first and second portions of the PUSCH communication after transmission by the UE. For example, the base station may receive, in the first set of uplink PRGs, the first portion of the PUSCH communication transmitted in the portion of the PUSCH resource that overlaps with the bandwidth of the SRS resource (for example, since the first portion of the PUSCH communication was precoded in the first set of uplink PRGs). Similarly, the base station may receive, in the second set of uplink PRGs, the second portion of the PUSCH communication transmitted in the portion of the PUSCH resource that does not overlap with the bandwidth of the SRS resource (for example, since the second portion of the PUSCH communication was precoded in the second set of uplink PRGs).

In some aspects a UE (for example, UE 120) may precode (at least a portion of) a PUSCH communication, to be transmitted in an uplink PRG, based at least in part on identifying an SRS resource associated with the uplink PRG.

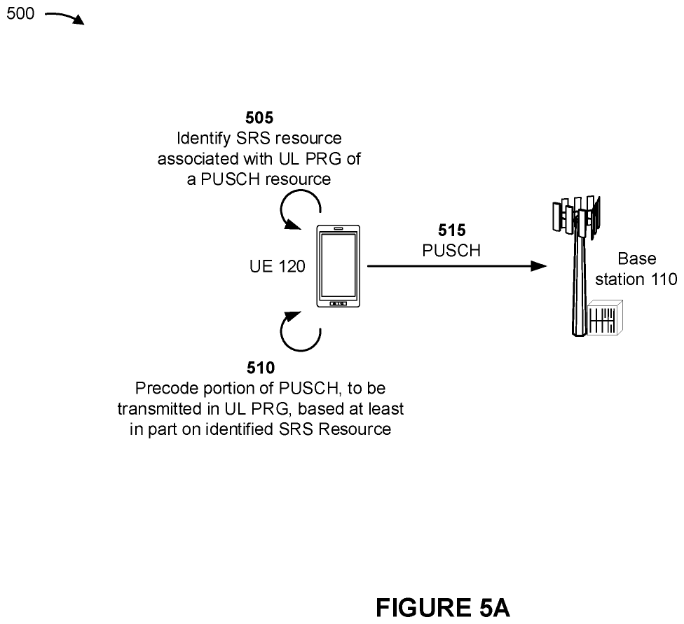

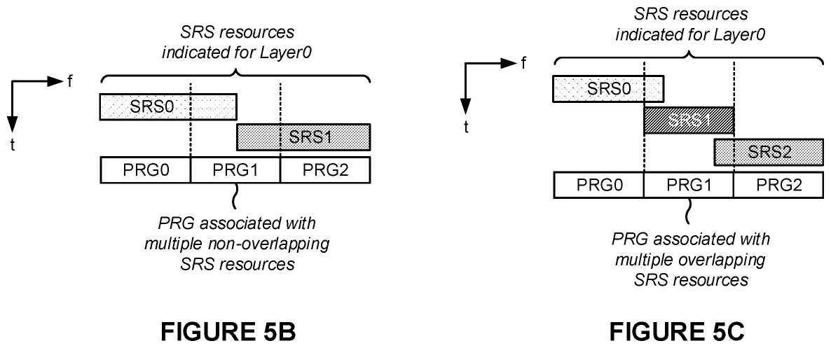

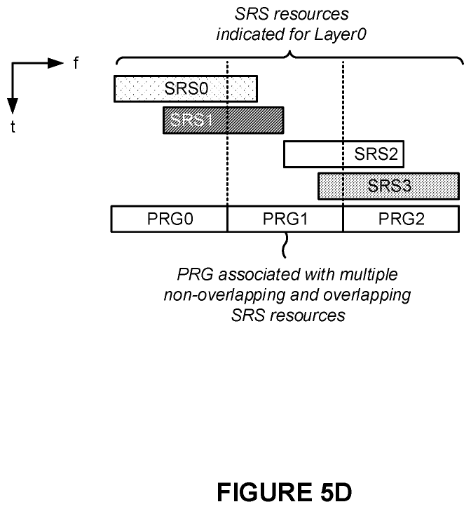

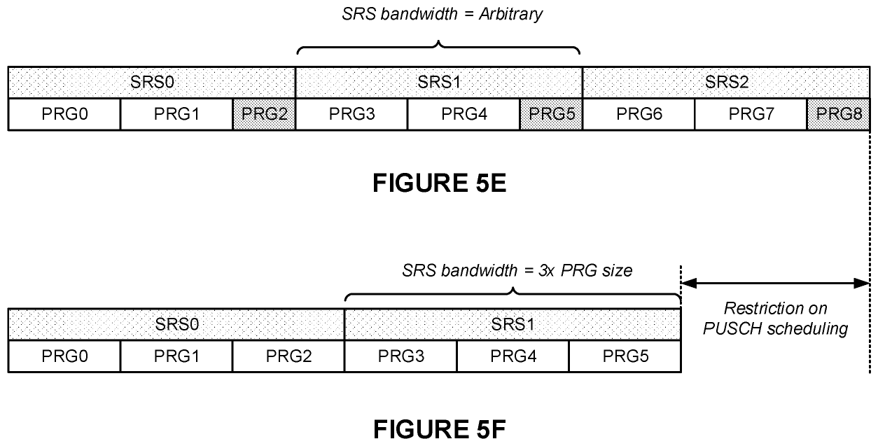

FIGS. 5A-5F are diagrams associated with an example illustrating precoding (at least a portion of) a PUSCH communication, to be transmitted in an uplink PRG, based at least in part on identifying an SRS resource associated with the uplink PRG. In FIGS. 5A-5F, the UE is configured with a set of SRS resources, and is scheduled to transmit a PUSCH communication in a PUSCH resource.

As shown in FIG. 5A, in a first operation 505, the UE may identify an SRS resource associated with the uplink PRG of the PUSCH resource. In other words, the UE may identify the SRS resource with which the uplink PRG is associated. In some aspects, the precoder used for precoding a portion of the PUSCH communication to be transmitted in resources of the uplink PRG may be determined or identified by information associated with the associated SRS resource. Thus, by identifying the SRS resource associated with the uplink PRG, the UE may identify the precoder to be used for precoding the portion of the PUSCH communication to be transmitted in resources of the uplink PRG. Additional details regarding various examples associated with identifying the SRS resource are provided below with regard to FIGS. 5B-5F.

In a second operation 510, the UE may precode a portion of the PUSCH communication, to be transmitted in the uplink PRG, based at least in part on the identified SRS resource. For example, the UE may precode a portion of the PUSCH communication, to be transmitted in resources of the uplink PRG, based at least in part on the identified SRS resource (for example, using a sub-band specific precoder associated with the SRS resource). In a third operation 515, the UE may transmit the PUSCH communication after precoding the PUSCH communication based at least in part on the identified SRS resource.

In some aspects, a base station (for example, base station 110) may receive a portion of the PUSCH communication after transmission by the UE. For example, the base station may identify the SRS resource associated with the uplink PRG of the PUSCH (for example, in a manner similar to that of the UE), and may receive the portion of the PUSCH communication, transmitted in the uplink precoding PRG, based at least in part on the identified SRS resource (for example, since the portion of the PUSCH communication was precoded in the uplink resource block group based at least in part on the identified SRS resource).

In some aspects, the SRS resource may be one of multiple SRS resources that occupy a frequency range comprising a bandwidth that is greater than or equal to a bandwidth of a PUSCH resource. Thus, in some aspects, the UE needs to identify the SRS resource from the multiple SRS resources with bandwidths overlapping the PUSCH resource.

In some aspects, two or more of the multiple SRS resources may at least partially overlap within a portion of the bandwidth of the PUSCH resource that corresponds to the uplink PRG. For example, in some aspects, uplink PRGs may be defined such that the uplink PRG is aligned with a common physical resource block associated with a downlink PRG. In such a case, multiple overlapping or non-overlapping SRS resource bandwidths may fall within the bandwidth of the uplink PRG. Examples of such cases are shown in FIGS. 5B-5D. In FIG. 5B, uplink PRG1 is associated with multiple non-overlapping SRS resources (for example, SRS0 and SRS1). In FIG. 5C, uplink PRG1 is associated with multiple overlapping SRS resources (for example, SRS0, SRS1, SRS2). In FIG. 5D, uplink PRG1 is associated with multiple non-overlapping and overlapping SRS resources (for example, SRS0, SRS1, SRS2, and SRS3).

In some aspects, the UE may identify the SRS resource, of the multiple SRS resources within the bandwidth of the uplink PRG, based at least in part on identifying an SRS resource having a frequency range overlapping with the uplink precoding resource block group that is greater than frequency ranges of other overlapping SRS resources overlapping with the uplink PRG. In other words, in some aspects, the UE may identify the SRS resource comprising the dominant frequency range within the bandwidth of the uplink PRG, and the identified SRS resource may be identified as the SRS resource associated with the uplink PRG.

In some aspects, the UE may identify the SRS resource, of the multiple SRS resources within the bandwidth of the uplink PRG, based at least in part on identifying the SRS resource having a greatest frequency range, within the frequency range of the uplink precoding resource block group, without overlap with frequency ranges of other SRS resources. For example, the UE may identify the SRS resource with the greatest frequency in the bandwidth of the uplink PRG that does not overlap with bandwidths of other SRS resources within the uplink PRG, and this SRS resource may be identified as the SRS resource associated with the uplink PRG.

In some aspects, the UE may identify the SRS resource, of the multiple SRS resources within the bandwidth of the uplink PRG, based at least in part on an index associated with the SRS resource. For example, the UE may identify the SRS resource with the highest index value, and the SRS resource with the highest index value may be identified as the SRS resource associated with the uplink PRG. As another example, the UE may identify the SRS resource with the lowest index value, and the SRS resource with the lowest index value may be identified as the SRS resource associated with the uplink PRG.

In some aspects, the UE may identify the SRS resource, of the multiple SRS resources within the bandwidth of the uplink PRG, based at least in part on an indication from a base station. For example, the UE may receive, from a base station (for example, base station 110), an indication (for example, an explicit indication or an implicit indication), that includes information that identifies the SRS resource to be associated with the uplink PRG.

In some aspects, a combination of two or more of the above-described techniques for identifying the SRS resource may be used.

In some aspects, the multiple SRS resources may not overlap within a portion of the bandwidth of the PUSCH resource that corresponds to the uplink PRG. For example, in some aspects, uplink PRGs may be defined such that the bandwidth of the uplink PRG overlaps with the bandwidth of only one SRS resource. Examples of such aspects are shown in FIGS. 5E and 5F. In such a case, the UE may identify the SRS resource based at least in part on the SRS resource being the only SRS resource with a bandwidth that overlaps the bandwidth of the uplink PRG.

In some aspects, as illustrated in FIG. 5E, a given uplink PRG may be one of a set of uplink precoding resource block groups mapped within a bandwidth of the SRS resource. Here, the bandwidth of the uplink PRG is different from bandwidths of other uplink PRGs of the set of uplink precoding resource block groups mapped within the bandwidth of the SRS resource. Generally, in such a case, a size of an uplink PRG may be predetermined. Then, a number of uplink PRGs of the predetermined size can be mapped within the bandwidth of a given SRS resource. As shown, in some aspects, if there is insufficient frequency range for an entire uplink of the predetermined size at an end of the bandwidth of the SRS resource, then a last uplink PRG within the bandwidth of the SRS resource may occupy the remaining bandwidth (that is, may have a comparatively smaller size, as illustrated by PRGs 2, 5, and 8 in FIG. 5E).

In some aspects, as illustrated in FIG. 5F, a bandwidth of the SRS resource may be a multiple of a bandwidth of the uplink PRG. In other words, the uplink PRG may be sized based at least in part on the bandwidth of the SRS resource. In such an aspect, as indicated in FIG. 5F, sizing uplink PRGs such that the bandwidth of the SRS resource is a multiple of the bandwidth of the uplink PRG may result in a restriction on PUSCH scheduling.

FIG. 6 is a diagram illustrating an example process 600 performed, for example, by a user equipment, in accordance with various aspects of the present disclosure. Example process 600 is an example where a user equipment (for example, user equipment 120 among other examples) performs operations associated with uplink PRG for NCB-based frequency-selective uplink precoding.

As shown in FIG. 6, in some aspects, process 600 may include determining whether a bandwidth of an SRS resource is smaller than a bandwidth of a PUSCH resource, or is greater than or equal to the bandwidth of the PUSCH resource (block 610). For example, the user equipment (for example, using receive processor 258, transmit processor 264, controller/processor 280, memory 282, among other examples) may determine whether a bandwidth of an SRS resource is smaller than a bandwidth of a PUSCH resource or is greater than or equal to the bandwidth of the PUSCH resource, as described above.

As further shown in FIG. 6, in some aspects, process 600 may include precoding a PUSCH communication, to be transmitted in the PUSCH resource, in either a single wideband uplink precoding resource block group, based on determining that the bandwidth of the SRS resource is smaller than the bandwidth of the PUSCH resource, or at least two uplink precoding resource block groups, based on determining that the bandwidth of the SRS resource is greater than or equal to the bandwidth of the PUSCH resource (block 620). For example, the user equipment (for example, using receive processor 258, transmit processor 264, controller/processor 280, memory 282, among other examples) may precode a PUSCH communication, to be transmitted in the PUSCH resource, in either a single wideband uplink precoding resource block group, based on determining that the bandwidth of the SRS resource is smaller than the bandwidth of the PUSCH resource, or at least two uplink precoding resource block groups, based on determining that the bandwidth of the SRS resource is greater than or equal to the bandwidth of the PUSCH resource; and, as described above.

As further shown in FIG. 6, in some aspects, process 600 may include transmitting the precoded PUSCH communication (block 630). For example, the user equipment (for example, using receive processor 258, transmit processor 264, controller/processor 280, memory 282, among other examples) may transmit the PUSCH communication after precoding the PUSCH communication, as described above.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram illustrating an example process 700 performed, for example, by a user equipment, in accordance with various aspects of the present disclosure. Example process 700 is an example where a user equipment (for example, user equipment 120 among other examples) performs operations associated with uplink PRG for NCB-based frequency-selective uplink precoding.

As shown in FIG. 7, in some aspects, process 700 may include precoding, in a first set of uplink precoding resource block groups, a first portion of a PUSCH communication that is to be transmitted in a portion of a PUSCH resource that overlaps with a bandwidth of an SRS resource (block 710). For example, the user equipment (for example, using receive processor 258, transmit processor 264, controller/processor 280, memory 282, among other examples) may precode, in a first set of uplink precoding resource block groups, a first portion of a PUSCH communication that is to be transmitted in a portion of a PUSCH resource that overlaps with a bandwidth of an SRS resource, as described above.

As further shown in FIG. 7, in some aspects, process 700 may include precoding, in a second set of uplink precoding resource block groups, a second portion of the PUSCH communication that is to be transmitted in a portion of the PUSCH resource that does not overlap with the bandwidth of the SRS resource (block 720). For example, the user equipment (for example, using receive processor 258, transmit processor 264, controller/processor 280, memory 282, among other examples) may precode, in a second set of uplink precoding resource block groups, a second portion of the PUSCH communication that is to be transmitted in a portion of the PUSCH resource that does not overlap with the bandwidth of the SRS resource, as described above.

As further shown in FIG. 7, in some aspects, process 700 may include transmitting the precoded PUSCH communication (block 730). For example, the user equipment (for example, using receive processor 258, transmit processor 264, controller/processor 280, memory 282, among other examples) may transmit the PUSCH communication after precoding the first portion of the PUSCH communication and the second portion of the PUSCH communication, as described above.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram illustrating an example process 800 performed, for example, by a user equipment, in accordance with various aspects of the present disclosure. Example process 800 is an example where a user equipment (for example, user equipment 120 among other examples) performs operations associated with uplink PRG for NCB-based frequency-selective uplink precoding.

As shown in FIG. 8, in some aspects, process 800 may include identifying an SRS resource associated with an uplink precoding resource block group of a PUSCH resource (block 810). For example, the user equipment (for example, using receive processor 258, transmit processor 264, controller/processor 280, memory 282, among other examples) may identify an SRS resource associated with an uplink precoding resource block group of a PUSCH resource, as described above.

As further shown in FIG. 8, in some aspects, process 800 may include precoding a portion of a PUSCH communication, to be transmitted in the uplink precoding resource block group, based at least in part on the identified SRS resource (block 820). For example, the user equipment (for example, using receive processor 258, transmit processor 264, controller/processor 280, memory 282, among other examples) may precode a portion of a PUSCH communication, to be transmitted in the uplink precoding resource block group, based at least in part on the identified SRS resource, as described above.

As further shown in FIG. 8, in some aspects, process 800 may include transmitting the precoded PUSCH communication (block 830). For example, the user equipment (for example, using receive processor 258, transmit processor 264, controller/processor 280, memory 282, among other examples) may transmit the PUSCH communication after precoding the PUSCH communication, as described above.

Process 800 may include additional aspects, such as any single aspect or any combination of aspects described below or in connection with one or more other processes described elsewhere herein.

In a first additional aspect, the SRS resource is one of multiple SRS resources occupying a frequency range comprising a bandwidth that is greater than or equal to a bandwidth of a PUSCH resource.

In a second additional aspect, alone or in combination with the first aspect, the uplink precoding resource block group is aligned with one or more common physical resource blocks associated with downlink precoding resource block groups.

In a third additional aspect, alone or in combination with one or more of the first and second aspects, the SRS resource is identified based at least in part on having a frequency range overlapping with the uplink precoding resource block group that is greater than frequency ranges of other overlapping SRS resources overlapping the uplink PRG.

In a fourth additional aspect, alone or in combination with one or more of the first through third aspects, the SRS resource is identified based at least in part on having a greatest frequency range, within a frequency range of the uplink precoding resource block group, without overlap with frequency ranges of other SRS resources.

In a fifth additional aspect, alone or in combination with one or more of the first through fourth aspects, the SRS resource is identified based at least in part on an index associated with the SRS resource.

In a sixth additional aspect, alone or in combination with one or more of the first through fifth aspects, process 800 includes receiving an indication from a base station, wherein the SRS resource is identified based at least in part on the indication.

In a seventh additional aspect, alone or in combination with one or more of the first through sixth aspects, the SRS resource is identified based at least in part on being an only SRS resource with a bandwidth that overlaps a bandwidth of the uplink precoding resource block group.

In an eighth additional aspect, alone or in combination with one or more of the first through seventh aspects, the uplink precoding resource block group is one of a set of uplink precoding resource block groups mapped within a bandwidth of the SRS resource.

In a ninth additional aspect, alone or in combination with one or more of the first through eighth aspects, a bandwidth of the uplink precoding resource block group is different than a bandwidth of other uplink precoding resource block groups of the set of uplink precoding resource block groups mapped within the bandwidth of the SRS resource.

In a tenth additional aspect, alone or in combination with one or more of the first through ninth aspects, a bandwidth of the SRS resource is a multiple of a bandwidth of the uplink precoding resource block group.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram illustrating an example process 900 performed, for example, by a base station, in accordance with various aspects of the present disclosure. Example process 900 is an example where a base station (for example, base station 110 among other examples) performs operations associated with uplink PRG for NCB-based frequency-selective uplink precoding.

As shown in FIG. 9, in some aspects, process 900 may include determining whether a bandwidth of an SRS resource is smaller than a bandwidth of a PUSCH resource or is greater than or equal to the bandwidth of the PUSCH resource (block 910). For example, the base station (for example, using transmit processor 220, receive processor 238, controller/processor 240, memory 242, among other examples) may determine whether a bandwidth of an SRS resource is smaller than a bandwidth of a PUSCH resource or is greater than or equal to the bandwidth of the PUSCH resource, as described above.

As further shown in FIG. 9, in some aspects, process 900 may include receiving a PUSCH communication, transmitted in the PUSCH resource, in either a single wideband uplink precoding resource block group, based on determining that the bandwidth of the SRS resource is smaller than the bandwidth of the PUSCH resource; or and at least two uplink precoding resource block groups, based on determining that the bandwidth of the SRS resource is greater than or equal to the bandwidth of the PUSCH resource (block 920). For example, the base station (for example, using receive processor 238, controller/processor 240, memory 242, among other examples) may receive a PUSCH communication, transmitted in the PUSCH resource, in either a single wideband uplink precoding resource block group, when the bandwidth of the SRS resource is determined to be smaller than the bandwidth of the PUSCH resource; or at least two uplink resource block groups, when the bandwidth of the SRS resource is determined to be greater than or equal to the bandwidth of the PUSCH resource, as described above.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram illustrating an example process 1000 performed, for example, by a base station, in accordance with various aspects of the present disclosure. Example process 1000 is an example where a base station (for example, base station 110 among other examples) performs operations associated with uplink PRG for NCB-based frequency-selective uplink precoding.

As shown in FIG. 10, in some aspects, process 1000 may include receiving, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups (block 1010). For example, the base station (for example, using receive processor 238, controller/processor 240, memory 242, among other examples) may receive, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups, as described above.

As further shown in FIG. 10, in some aspects, process 1000 may include receiving, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups (block 1020). For example, the base station (for example, using transmit processor 220, receive processor 238, controller/processor 240, memory 242, among other examples) may receive, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups, as described above. In some aspects, the second portion of the PUSCH communication was precoded in the second set of uplink precoding resource block groups.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram illustrating an example process 1100 performed, for example, by a base station, in accordance with various aspects of the present disclosure. Example process 1100 is an example where a base station (for example, base station 110 among other examples) performs operations associated with uplink PRG for NCB-based frequency-selective uplink precoding.

As shown in FIG. 11, in some aspects, process 1100 may include identifying an SRS resource associated with an uplink precoding resource block group of a PUSCH resource (block 1110). For example, the base station (for example, using transmit processor 220, receive processor 238, controller/processor 240, memory 242, among other examples) may identify an SRS resource associated with an uplink precoding resource block group of a PUSCH resource, as described above.

As further shown in FIG. 11, in some aspects, process 1100 may include receiving a portion of a PUSCH communication, transmitted in the uplink precoding resource block group, based at least in part on the identified SRS resource, wherein the portion of the PUSCH communication was precoded in the uplink resource block group based at least in part on the identified SRS resource (block 1120). For example, the base station (for example, using receive processor 238, controller/processor 240, memory 242, among other examples) may receive a portion of a PUSCH communication, transmitted in the uplink precoding resource block group, based at least in part on the identified SRS resource, wherein the portion of the PUSCH communication was precoded in the uplink resource block group based at least in part on the identified SRS resource, as described above.

Process 1100 may include additional aspects, such as any single aspect or any combination of aspects described below or in connection with one or more other processes described elsewhere herein.

In a first additional aspect, the SRS resource is one of multiple SRS resources occupying a frequency range comprising a bandwidth that is greater than or equal to a bandwidth of a PUSCH resource.

In a second additional aspect, alone or in combination with the first aspect, the uplink precoding resource block group is aligned with one or more common physical resource blocks associated with downlink precoding resource block groups.

In a third additional aspect, alone or in combination with one or more of the first and second aspects, the SRS resource is identified based at least in part on having a frequency range overlapping with the uplink precoding resource block group that is greater than frequency ranges of other overlapping SRS resources overlapping with the uplink precoding resource block group.

In a fourth additional aspect, alone or in combination with one or more of the first through third aspects, the SRS resource is identified based at least in part on having a greatest frequency range, within a frequency range of the uplink precoding resource block group, without overlap with frequency ranges of other SRS resources.

In a fifth additional aspect, alone or in combination with one or more of the first through fourth aspects, the SRS resource is identified based at least in part on an index associated with the SRS resource.

In a sixth additional aspect, alone or in combination with one or more of the first through fifth aspects, the SRS resource is identified based at least in part on being an only SRS resource with a bandwidth that overlaps a bandwidth of the uplink precoding resource block group.

In an seventh additional aspect, alone or in combination with one or more of the first through sixth aspects, the uplink precoding resource block group is one of a set of uplink precoding resource block groups mapped within a bandwidth of the SRS resource.

In a eighth additional aspect, alone or in combination with one or more of the first through seventh aspects, a bandwidth of the uplink precoding resource block group is different than a bandwidth of other uplink precoding resource block groups of the set of uplink precoding resource block groups mapped within the bandwidth of the SRS resource.

In a ninth additional aspect, alone or in combination with one or more of the first through eighth aspects, a bandwidth of the SRS resource is a multiple of a bandwidth of the uplink precoding resource block group.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

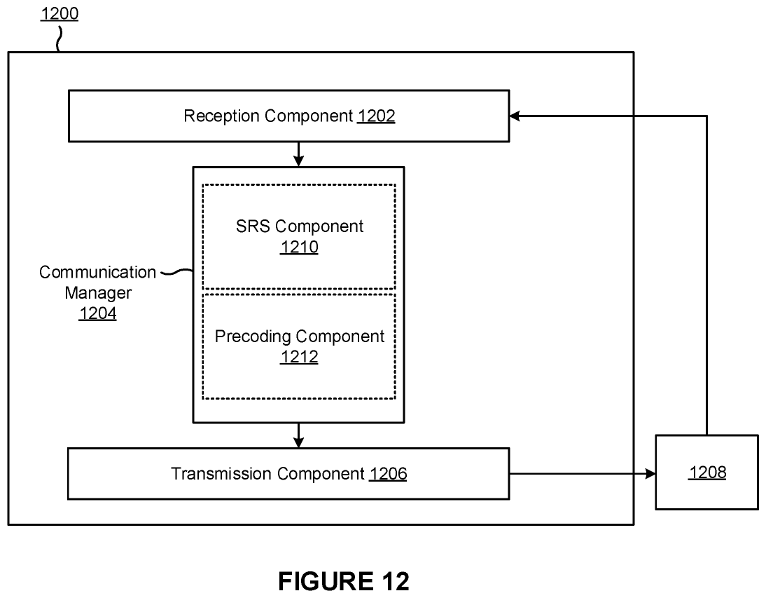

FIG. 12 is a block diagram of an example apparatus 1200 for wireless communication in accordance with various aspects of the present disclosure. The apparatus 1200 may be a UE, or a UE may include the apparatus 1200. In some aspects, the apparatus 1200 includes a reception component 1202, a communication manager 1204, and a transmission component 1206, which may be in communication with one another (for example, via one or more buses). As shown, the apparatus 1200 may communicate with another apparatus 1208 (such as a UE, a base station, or another wireless communication device) using the reception component 1202 and the transmission component 1206.

In some aspects, the apparatus 1200 may be configured to perform one or more operations described herein in connection with FIG. 3, 4A-4C, or 5A-5F. Additionally or alternatively, the apparatus 1200 may be configured to perform one or more processes described herein, such as process 600 of FIG. 6, process 700 of FIG. 7, process 800 of FIG. 8, or a combination thereof. In some aspects, the apparatus 1200 may include one or more components of the UE described above in connection with FIG. 2.

The reception component 1202 may receive communications, such as reference signals, control information, data communications, or a combination thereof, from the apparatus 1208. The reception component 1202 may provide received communications to one or more other components of the apparatus 1200, such as the communication manager 1204. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a demodulator, a MIMO detector, a receive processor, a controller/processor, a memory, or a combination thereof, of the UE described above in connection with FIG. 2.

The transmission component 1206 may transmit communications, such as reference signals, control information, data communications, or a combination thereof, to the apparatus 1208. In some aspects, the communication manager 1204 may generate communications and may transmit the generated communications to the transmission component 1206 for transmission to the apparatus 1208. In some aspects, the transmission component 1206 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1206 may include one or more antennas, a modulator, a transmit MIMO processor, a transmit processor, a controller/processor, a memory, or a combination thereof, of the UE described above in connection with FIG. 2. In some aspects, the transmission component 1206 may be co-located with the reception component 1202 in a transceiver.

In some aspects, the communication manager 1204 may determining whether a bandwidth of an SRS resource is smaller than a bandwidth of a PUSCH resource or is greater than or equal to the bandwidth of the PUSCH resource. In some aspects, the communication manager 1204 may precode a PUSCH communication, to be transmitted in the PUSCH resource, in either a single wideband uplink precoding resource block group, based on determining that the bandwidth of the SRS resource is smaller than the bandwidth of the PUSCH resource, or at least two uplink precoding resource block groups, based on determining that the bandwidth of the SRS resource is greater than or equal to the bandwidth of the PUSCH resource. In some aspects, the communication manager 1204 may transmit or may cause the transmission component 1206 to transmit the precoded PUSCH communication.

In some aspects, the communication manager 1204 may precode, in a first set of uplink precoding resource block groups, a first portion of a PUSCH communication that is to be transmitted in a portion of a PUSCH resource that overlaps with a bandwidth of an SRS resource. In some aspects, the communication manager 1204 may precode, in a second set of uplink precoding resource block groups, a second portion of the PUSCH communication that is to be transmitted in a portion of the PUSCH resource that does not overlap with the bandwidth of the SRS resource. In some aspects, the communication manager 1204 may transmit or may cause the transmission component 1206 to transmit the precoded PUSCH communication.

In some aspects, the communication manager 1204 may identify an SRS resource associated with an uplink precoding resource block group of a PUSCH resource. In some aspects, the communication manager 1204 may precode a portion of a PUSCH communication, to be transmitted in the uplink precoding resource block group, based at least in part on the identified SRS resource. In some aspects, the communication manager 1204 may transmit or may cause the transmission component 1206 to transmit the precoded PUSCH communication.

In some aspects, the communication manager 1204 may include a controller/processor, a memory, or a combination thereof, of the UE described above in connection with FIG. 2.

In some aspects, the communication manager 1204 may include a set of components, such as an SRS component 1210, a precoding component 1212, or a combination thereof. Alternatively, the set of components may be separate and distinct from the communication manager 1204. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

In some aspects, the SRS component 1210 may determine whether a bandwidth of an SRS resource is smaller than a bandwidth of a PUSCH resource or is greater than or equal to the bandwidth of the PUSCH resource. In some aspects, the precoding component 1212 may precode a PUSCH communication, to be transmitted in the PUSCH resource, in either a single wideband uplink precoding resource block group, based on determining that the bandwidth of the SRS resource is smaller than the bandwidth of the PUSCH resource, or at least two uplink precoding resource block groups, based on determining that the bandwidth of the SRS resource is greater than or equal to the bandwidth of the PUSCH resource. In some aspects, the transmission component 1206 may transmit the precoded PUSCH communication.

In some aspects, the precoding component 1212 may precode, in a first set of uplink precoding resource block groups, a first portion of a PUSCH communication that is to be transmitted in a portion of a PUSCH resource that overlaps with a bandwidth of an SRS resource. In some aspects, the precoding component 1212 may precode, in a second set of uplink precoding resource block groups, a second portion of the PUSCH communication that is to be transmitted in a portion of the PUSCH resource that does not overlap with the bandwidth of the SRS resource. In some aspects, the transmission component 1206 may transmit the precoded PUSCH communication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

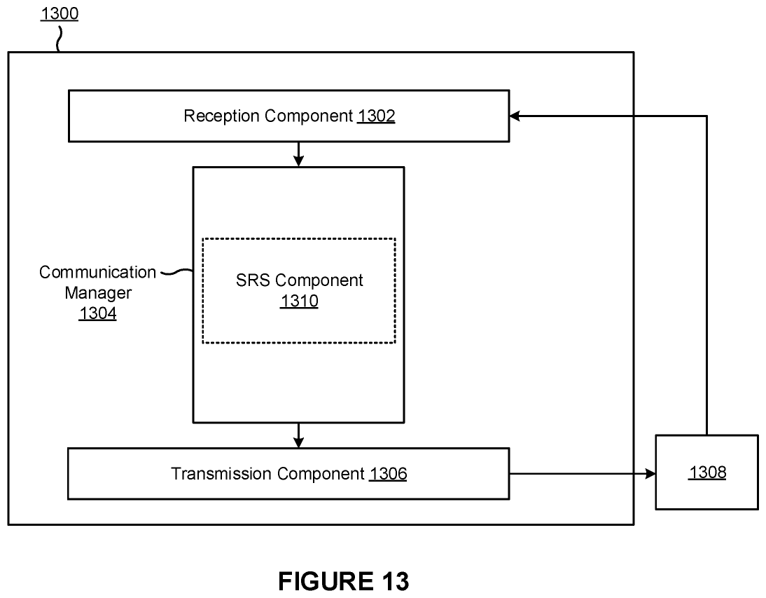

FIG. 13 is a block diagram of an example apparatus 1300 for wireless communication in accordance with various aspects of the present disclosure. The apparatus 1300 may be a base station, or a base station may include the apparatus 1300. In some aspects, the apparatus 1300 includes a reception component 1302, a communication manager 1304, and a transmission component 1306, which may be in communication with one another (for example, via one or more buses). As shown, the apparatus 1300 may communicate with another apparatus 1308 (such as a UE, a base station, or another wireless communication device) using the reception component 1302 and the transmission component 1306.

In some aspects, the apparatus 1300 may be configured to perform one or more operations described herein in connection with FIG. 3, 4A-4C, or 5A-5F. Additionally or alternatively, the apparatus 1300 may be configured to perform one or more processes described herein, such as process 900 of FIG. 9, process 1000 of FIG. 10, process 1100 of FIG. 11, or a combination thereof. In some aspects, the apparatus 1300 may include one or more components of the base station described above in connection with FIG. 2.

The reception component 1302 may receive communications, such as reference signals, control information, data communications, or a combination thereof, from the apparatus 1308. The reception component 1302 may provide received communications to one or more other components of the apparatus 1300, such as the communication manager 1304. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a demodulator, a MIMO detector, a receive processor, a controller/processor, a memory, or a combination thereof, of the base station described above in connection with FIG. 2.

The transmission component 1306 may transmit communications, such as reference signals, control information, data communications, or a combination thereof, to the apparatus 1308. In some aspects, the communication manager 1304 may generate communications and may transmit the generated communications to the transmission component 1306 for transmission to the apparatus 1308. In some aspects, the transmission component 1306 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1306 may include one or more antennas, a modulator, a transmit MIMO processor, a transmit processor, a controller/processor, a memory, or a combination thereof, of the base station described above in connection with FIG. 2. In some aspects, the transmission component 1306 may be co-located with the reception component 1302 in a transceiver.

In some aspects, the communication manager 1304 may determine whether a bandwidth of an SRS resource is smaller than a bandwidth of a PUSCH resource or is greater than or equal to the bandwidth of the PUSCH resource. In some aspects, the communication manager 1304 may receive or may cause the reception component 1302 to receive a PUSCH communication, transmitted in the PUSCH resource, in either a single wideband uplink precoding resource block group, based on determining that the bandwidth of the SRS resource is smaller than the bandwidth of the PUSCH resource, or at least two uplink precoding resource block groups, based on determining that the bandwidth of the SRS resource is greater than or equal to the bandwidth of the PUSCH resource.

In some aspects, the communication manager 1304 may receive or may cause the reception component 1302 to receive, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. In some aspects, the communication manager 1304 may receive or may cause the reception component 1302 to receive, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, the communication manager 1304 may identify an SRS resource associated with an uplink precoding resource block group of a PUSCH resource. In some aspects, the communication manager 1304 may receive or may cause the reception component 1302 to receive a portion of a PUSCH communication, transmitted in the uplink precoding resource block group, based at least in part on the identified SRS resource, wherein the portion of the PUSCH communication was precoded in the uplink resource block group based at least in part on the identified SRS resource.

In some aspects, the communication manager 1304 may include a controller/processor, a memory, a scheduler, a communication unit, or a combination thereof, of the base station described above in connection with FIG. 2.

In some aspects, the communication manager 1304 may include a set of components, such as an SRS component 1310. Alternatively, the set of components may be separate and distinct from the communication manager 1304. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

In some aspects, the SRS component 1310 may determine whether a bandwidth of an SRS resource is smaller than a bandwidth of a PUSCH resource or is greater than or equal to the bandwidth of the PUSCH resource. In some aspects, the reception component 1302 may receive a PUSCH communication, transmitted in the PUSCH resource, in either a single wideband uplink precoding resource block group, when the bandwidth of the SRS resource is determined to be smaller than the bandwidth of the PUSCH resource, or at least two uplink resource block groups, when the bandwidth of the SRS resource is determined to be greater than or equal to the bandwidth of the PUSCH resource.

In some aspects, the reception component 1302 may receive, in a first set of uplink precoding resource block groups, a first portion of a PUSCH communication transmitted in a portion of a PUSCH resource that overlaps with a bandwidth of an SRS resource, wherein the first portion of the PUSCH communication was precoded in the first set of uplink precoding resource block groups. In some aspects, the reception component 1302 may receive, in a second set of uplink precoding resource block groups, a second portion of the PUSCH communication transmitted in a portion of the PUSCH resource that does not overlap with the bandwidth of the SRS resource, wherein the second portion of the PUSCH communication was precoded in the second set of uplink precoding resource block groups.

In some aspects, the SRS component 1310 may identify an SRS resource associated with an uplink precoding resource block group of a PUSCH resource. In some aspects, the reception component 1302 may receive a portion of a PUSCH communication, transmitted in the uplink precoding resource block group, based at least in part on the identified SRS resource, wherein the portion of the PUSCH communication was precoded in the uplink resource block group based at least in part on the identified SRS resource.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, among other examples.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (for example, related items, unrelated items, a combination of related and unrelated items, among other examples), and may be used interchangeably with “one or more.” Where only one item is intended, the phrase “only one” or similar language is used. Also, as used herein, the terms “has,” “have,” “having,” among other examples are intended to be open-ended terms. Further, the phrase “based on” is intended to mean “based, at least in part, on” unless explicitly stated otherwise.

1. A method of wireless communication performed by a user equipment, comprising:
determining whether a bandwidth of a sounding reference signal (SRS) resource is smaller than a bandwidth of a physical uplink shared channel (PUSCH) resource or is greater than or equal to the bandwidth of the PUSCH resource;
precoding a PUSCH communication, to be transmitted in the PUSCH resource, in either:
a single wideband uplink precoding resource block group based on determining that the bandwidth of the SRS resource is smaller than the bandwidth of the PUSCH resource; or
at least two uplink precoding resource block groups based on determining that the bandwidth of the SRS resource is greater than or equal to the bandwidth of the PUSCH resource; and
transmitting the precoded PUSCH communication.

2. (canceled)

3. A method of wireless communication performed by a user equipment, comprising:
identifying a sounding reference signal (SRS) resource associated with an uplink precoding resource block group of a physical uplink shared channel (PUSCH) resource;
precoding a portion of a PUSCH communication, to be transmitted in the uplink precoding resource block group, based at least in part on the identified SRS resource; and
transmitting the precoded PUSCH communication.

4. The method of claim 3, wherein the SRS resource is one of multiple SRS resources occupying a frequency range comprising a bandwidth that is greater than or equal to a bandwidth of the PUSCH resource.

5. The method of claim 3, wherein the uplink precoding resource block group is aligned with one or more common physical resource blocks associated with downlink precoding resource block groups.

6. The method of claim 3, wherein the SRS resource is identified based at least in part on having a frequency range overlapping with the uplink precoding resource block group that is greater than frequency ranges of other overlapping SRS resources overlapping with the uplink precoding resource block group.

7. The method of claim 3, wherein the SRS resource is identified based at least in part on having a greatest frequency range, within a frequency range of the uplink precoding resource block group, without overlap with frequency ranges of other SRS resources.

8. The method of claim 3, wherein the SRS resource is identified based at least in part on an index associated with the SRS resource.

9. The method of claim 3, further comprising receiving an indication from a base station, wherein the SRS resource is identified based at least in part on the indication.

10. The method of claim 3, wherein the SRS resource is identified based at least in part on being an only SRS resource with a bandwidth that overlaps a bandwidth of the uplink precoding resource block group.

11. The method of claim 3, wherein the uplink precoding resource block group is one of a set of uplink precoding resource block groups mapped within a bandwidth of the SRS resource.

12. The method of claim 11, wherein a bandwidth of the uplink precoding resource block group is different than a bandwidth of other uplink precoding resource block groups of the set of uplink precoding resource block groups mapped within the bandwidth of the SRS resource.

13. The method of claim 3, wherein a bandwidth of the SRS resource is a multiple of a bandwidth of the uplink precoding resource block group.

14. (canceled)

15. A user equipment for wireless communication, comprising:
a memory; and
one or more processors operatively coupled to the memory, the memory and the one or more processors configured to:
precode, in a first set of uplink precoding resource block groups, a first portion of a physical uplink shared channel (PUSCH) communication that is to be transmitted in a portion of a PUSCH resource that overlaps with a bandwidth of a sounding reference signal (SRS) resource;
precode, in a second set of uplink precoding resource block groups, a second portion of the PUSCH communication that is to be transmitted in a portion of the PUSCH resource that does not overlap with the bandwidth of the SRS resource; and
transmit the precoded PUSCH communication.

16. A user equipment for wireless communication, comprising:
a memory; and
one or more processors operatively coupled to the memory, the memory and the one or more processors configured to:
identify a sounding reference signal (SRS) resource associated with an uplink precoding resource block group of a physical uplink shared channel (PUSCH) resource;
precode a portion of a PUSCH communication, to be transmitted in the uplink precoding resource block group, based at least in part on the identified SRS resource; and
transmit the precoded PUSCH communication.

17. The UE of claim 16, wherein the SRS resource is one of multiple SRS resources occupying a frequency range comprising a bandwidth that is greater than or equal to a bandwidth of the PUSCH resource.

18. The UE of claim 16, wherein the uplink precoding resource block group is aligned with one or more common physical resource blocks associated with downlink precoding resource block groups.

19. The UE of claim 16, wherein the SRS resource is identified based at least in part on having a frequency range overlapping with the uplink precoding resource block group that is greater than frequency ranges of other overlapping SRS resources overlapping with the uplink precoding resource block group.

20. The UE of claim 16, wherein the SRS resource is identified based at least in part on having a greatest frequency range, within a frequency range of the uplink precoding resource block group, without overlap with frequency ranges of other SRS resources.

21. The UE of claim 16, wherein the SRS resource is identified based at least in part on an index associated with the SRS resource.

22. The UE of claim 16, further comprising receiving an indication from a base station, wherein the SRS resource is identified based at least in part on the indication.

23. The UE of claim 16, wherein the SRS resource is identified based at least in part on being an only SRS resource with a bandwidth that overlaps a bandwidth of the uplink precoding resource block group.

24. The UE of claim 16, wherein the uplink precoding resource block group is one of a set of uplink precoding resource block groups mapped within a bandwidth of the SRS resource.

25. The UE of claim 24, wherein a bandwidth of the uplink precoding resource block group is different than a bandwidth of other uplink precoding resource block groups of the set of uplink precoding resource block groups mapped within the bandwidth of the SRS resource.

26. The UE of claim 16, wherein a bandwidth of the SRS resource is a multiple of a bandwidth of the uplink precoding resource block group.

27. (canceled)

28. (canceled)

29. An apparatus for wireless communication, comprising:
means for identifying a sounding reference signal (SRS) resource associated with an uplink precoding resource block group of a physical uplink shared channel (PUSCH) resource;
means for precoding a portion of a PUSCH communication, to be transmitted in the uplink precoding resource block group, based at least in part on the identified SRS resource; and
means for transmitting the PUSCH communication after precoding the PUSCH communication.

30. The apparatus of claim 29, wherein the SRS resource is one of multiple SRS resources occupying a frequency range comprising a bandwidth that is greater than or equal to a bandwidth of the PUSCH resource.

31. The apparatus of claim 29, wherein the uplink precoding resource block group is aligned with one or more common physical resource blocks associated with downlink precoding resource block groups.

32. The apparatus of claim 29, wherein the SRS resource is identified based at least in part on having a frequency range overlapping with the uplink precoding resource block group that is greater than frequency ranges of other overlapping SRS resources overlapping with the uplink precoding resource block group.

33. The apparatus of claim 29, wherein the SRS resource is identified based at least in part on having a greatest frequency range, within a frequency range of the uplink precoding resource block group, without overlap with frequency ranges of other SRS resources.

34. The apparatus of claim 29, wherein the SRS resource is identified based at least in part on an index associated with the SRS resource.

35. The apparatus of claim 29, further comprising receiving an indication from a base station, wherein the SRS resource is identified based at least in part on the indication.

36. The apparatus of claim 29, wherein the SRS resource is identified based at least in part on being an only SRS resource with a bandwidth that overlaps a bandwidth of the uplink precoding resource block group.

37. The apparatus of claim 29, wherein the uplink precoding resource block group is one of a set of uplink precoding resource block groups mapped within a bandwidth of the SRS resource.

38. The apparatus of claim 37, wherein a bandwidth of the uplink precoding resource block group is different than a bandwidth of other uplink precoding resource block groups of the set of uplink precoding resource block groups mapped within the bandwidth of the SRS resource.

39. The apparatus of claim 29, wherein a bandwidth of the SRS resource is a multiple of a bandwidth of the uplink precoding resource block group.

40-75. (canceled)
